(19) United States
(12) Patent Application Publication
(10) Pub. No.: US 2007/0184403 A1
(43) Pub. Date: Aug. 9, 2007

(54) No Distortion Impression Tray and Method of Use

(76) Inventor: Allan COOPERSMITH, Montreal (CA)

Correspondence Address: OSLER, HOSKIN & HARCOURT, LLP (OTHER), 1000 DE LA GAUCHETIERE STREET WEST, SUITE 2100, MONTREAL, QC, H3B-4W5, US

(21) Appl. No.: 11/671,876

(22) Filed: Feb. 6, 2007

Related U.S. Application Data
(60) Provisional application No. 60/765,597, filed on Feb. 7, 2006.

(51) Int. Cl. A61C 9/00

(52) U.S. Cl. 433/37

(57) ABSTRACT

A device for obtaining an impression for a tooth or plurality of teeth or oral structures comprising a receptacle to hold impression material, to which has been affixed a body, said body which can be adjusted to engage teeth and oral structures thereby increasing stability, limiting the movement of the receptacle as the impression material sets, directing impression material towards the area to be restored, and confining impression material within the receptacle. A method of use is also discussed.

The present application claims the benefit of U.S. Provisional Patent Application Ser. No. 60/765,597, filed Feb. 7, 2006, entitled “No-Distortion Dental Tray”, the contents of which are incorporated herein by reference.

### FIELD OF THE INVENTION

This invention relates to apparati and methods employed by dental practitioners to obtain an impression of teeth and/or surrounding structures using a receptacle or tray to contain and carry and deliver impression material in such a manner so as to be stable and secure and resistant to movement or uneven or intermittent pressure reducing spillage and pulling and deformation and inaccuracies of the impression thereby ensuring a well fitting and more accurate prosthetic.

### BACKGROUND OF THE INVENTION

The process of obtaining an impression of a tooth and/or surrounding structures is customarily done by filling a receptacle or dental tray or container with soft, unset impression material and inserting said tray over the teeth and compressing the tray so that the impression material is directed over the teeth and then is allowed to harden or set. Movement however small during this procedure will lead to distortions and inaccuracies in the impression which produces inaccuracies in the final prosthetic.

The taking of an impression is an unnatural and uncomfortable and disquieting procedure for the patient. As the tray which is filled with soft flowable impression material is placed over the teeth and surrounding structures, a patient often moves or closes their mouth or attempts to displace the tray with their lips or tongue or cheeks. As the impression material is initially soft, the tray tends to be pushed down over the teeth and surrounding structures until the inner aspect of the tray touches said teeth or structures thereby creating voids, pressure points leading in turn to inaccuracies and poorly fitting prosthetics. It is almost impossible for the operator to compress the soft impression material and stop short of hitting or engaging the inner aspect of the dental tray and to continue to hold the tray absolutely still and stable without any movement as the soft impression material sets. Some trays or containers incorporate a small protrusion on the inner aspect so as to act as a protrusion or ledge (occlusal stop) which limits the movement of the tray or container in a gingival direction so as to allow for an adequate amount of impression material between the inner aspect of the dental tray and the occlusal aspect of the teeth or oral structures. These trays are typically custom made from and additional preliminary impression which require an additional appointment, and additional cost and time. Custom and some stock trays may contain occlusal stops which are hard and rigid and are non-adjustable to fit variations in tooth size and arrangements, and do not stabilize the tray in a horizontal or lateral direction. Most trays are open ended in which the proximal and distal ends are in line with the base of the tray. Some trays taper at the proximal and distal ends to be completely flat. This allows the tray to have a universal fit over teeth and oral structures of varying sizes and shapes. The open ends of the dental tray or container allows for spillage of impression material out of the tray away from the areas to be restored, towards the back of the mouth often leading to gagging and choking thereby contributing to patient discomfort and movement. There is a need for a dental impression tray or container which is stable and resists movement when placed over teeth and oral tissues, and directs the impression material towards the area to be restored. This receptacle or tray should be adjustable to fit various mouth shapes and tooth configurations.

### SUMMARY OF THE INVENTION

It is therefore an object of an aspect the present invention to provide an improved apparatus for taking an impression of a tooth or teeth, and/or surrounding structures to receive a dental restoration, such as but not limited to a crown, inlay, onlay, partial or complete prosthesis, or implant supported, fixed or removable prosthesis.

It is a further object of an aspect of the present invention to provide an improved apparatus which will be more secure and stable when it is inserted into the mouth over the teeth and surrounding structures.

It is a further object of this invention to provide an improved apparatus to accomplish both delivery and improved distribution of impression material to engulf and surround the teeth and supporting structures.

Most impression materials are of a soft, fluid or flowable consistency and as the tray which is filled with the impression material is placed over the teeth and supporting structures, there is little resistance placed on the soft or fluid impression material thereby resulting in over seating, dental tray or container impingement, vertical and lateral movements, inaccuracies, and distortions.

It is a further object of this invention to provide an improved apparatus which has a body which may act as an occlusal stop which engages the adjacent teeth and/or oral structures so as to prevent the tray or container to be overly compressed minimizing deformation and inaccuracies.

Most trays are open on the ends in order to allow seating of the tray over various sizes and configurations of teeth and supporting structures. A disadvantage of the open ends is that the impression material is allowed to leak out often causing voids in the area as well as causing patient gagging and movement resulting in patient discomfort and costly redo's.

It is a further object of this invention to provide an improved apparatus which has borders (to limit the proximal and distal open ends of an impression tray) to contain or confine and direct impression material to the desired area.

It is a preferred object of this present invention to provide a body forming a boundary/occlusal stop which is mouldable and compressible and deformably rigid so as to offer a limit as well as an occlusal stop and still allow the seating of the impression tray over the desired teeth and supporting structures.

It is an object of an aspect of this invention to provide a device in which the body or plurality of bodies acting as a border and occlusal stop may be distinctly separate structures or may be one and the same.

It is a preferred object of the present invention to provide a material which may be referred to as “compression material” which may form the body comprising a, or plurality of boundaries and/or occlusal stops and said material may transform any tray commonly used in dentistry to take an impression into a “No-distortion” tray.

In one aspect, as embodied and broadly described herein, the present invention provides a device for taking an impression using a tray comprising a body which engages and grabs onto structures such as teeth or gums and resists partially the compressive pressure exerted by the dental professional as the tray is placed over the teeth and/or gums. Because a body can function as a border (s) which walls off the proximal and distal ends of the impression tray, it is deformably rigid; it may act to better contain and direct the impression material as well as act as an occlusal stop. It is preferable that the body forming a boundary and/or occlusal stop should be adjustable to fit various sizes and shapes of oral structures. The body may remain plastic and deformably rigid or may harden or set as the impression material hardens and sets. The material comprising the body may harden or set. The hardening or setting of said material may occur chemically, thermally, or by the elapse of time or by light activation.

It is a preferred object of this present invention that the body forming the border and/or occlusal stop be compressable and deformably rigid so that the tray or container may be held and secured by the teeth and structures adjacent to the area to be restored, yet allow for apical pressure to be generated by the tray and thus impression material in a more controlled and precise manner. The resistance offered by the compressible deformably rigid body forming a boundary/occlusal stop provides stability of the tray and reduces movement and excessive pressure on the impression material which would lead to deformation and inaccuracy.

The body forming a border and/or occlusal stop of the present invention may be a semi solid or a gel, or putty or rubber or silicone type of material or a material or a paste which can transform or harden or set into a semi solid or solid. This material can be of a consistency that allows it to be easily attached to the tray or container. Said material may be adhered to the tray in such a manner so as to be movable and adjustable to fit various quantities and configurations of teeth and oral structures.

The occlusal stops help to form a distal boundary which limits and confines the impression material within the tray thereby preventing spillage into the posterior part of the mouth. It is preferable that the occlusal stops be positioned in the dental impression tray at the distal ends as well as the anterior area to form a tripod effect in order to offer a more stable result. It is highly preferable that the occlusal stop be placed in areas of the tray which correspond to structures that will not be restored. For example if teeth #23, 24, 25, were to be restored, the occlusal stops would be preferably placed anterior to #23 and distal to #25, and not in the area of 23, 24, or 25. A border can be composed of the same material as an occlusal stop and can function in the same manner. A border will serve to close or limit an open end of an impression tray (distal ends and facial aspect of the palate), and an occlusal stop, which is usually but not necessarily smaller, can be placed anywhere in the impression tray.

It is preferable that impression trays which only partially cover an arch such as but not limited to sectional or quadrant, impression trays, contain only a posterior and anterior body, as the tripod effect is more important for full arch trays.

The body comprising a material may preferably be deformably rigid; the material should partially retain its shape (not deform) under forces less than the amount necessary to compress it over the teeth and supporting structures.

The body comprising a material may be resistant to tearing while being deformed. Once deformed it should retain its new shape. It should not tend to return to its original pre-deformation shape because the material may also act as part of the impression, or be easily removable once the impression material is set.

The operator must fill the tray with a semi solid impression material and then insert said tray into a mouth, and gently press in a gingival direction with just enough pressure to compress the impression material and stop pressing just shy of the teeth touching the interior of the tray.

A body acting as a border, can be composed of the same material as a body acting as an occlusal stop

As impression material is inserted into the tray covering the occlusal stops which also act as a boundary, they are engulfed by and covered with set impression material.

A body may be comprised of a material that is similar to or that will fuse with impression material so that the body will be incorporated into the impression. In some instances it may be preferable that a body may be made to be removed from the set impression material before a positive model is poured, in which case it would be desirable that the body be comprised of a material that does not fuse with impression material. Such non-limiting examples may be wax, rubber, plastic.

It is important to note that the material forming the body forming a boundary and/or occlusal stop may be manufactured as part of the dental tray or container, or may be added to any tray prior to taking the impression, thereby transforming the standard or stock tray into a No-Distort™ tray (no-distortion tray). It is desirable that the “occlusal stop or border material” be adjustable so as to be positioned in various locations within the tray.

As a non limiting example, the material can be added to limit the boundary of a tray and create an occlusal stop by inserting such dense, compressible, deformably rigid material into the tray just prior to inserting the unset impression material, and the “occlusal stop or border material” may set and/or become incorporated within the impression. Said “occlusal stop or border material” may be releaseably attached to the impression tray and set impression material so that it can be removed before the impression is pored to form a model.

The material of the present invention may be manufactured by any conventional means appropriate for the materials of which they are constructed. As a non-limiting example, the material used to form the body comprising a boundary and/or occlusal stop may be formed by mixing a powder and a liquid or a paste and a paste, or a paste and a liquid or a paste and a powder, or a gel with one or more of the aforementioned. The constituents may be mixed either by hand or in a mixing device such as but not limited to an automixing chamber (“automixing gun” or “automixing syringe”) or in a capsule which is then triturated or mixed in a dental triturator. By way of non-limiting example the components may be contained in separate compartments of a dental capsule and then activated (the internal membrane is punctured allowing the components to be mixed) and then triturated in a dental triturator. This capsule can have a nozzle through which the mixed retraction material can be inserted into the impression tray. The material may be comprised of one of or a plurality of, or a combination of, from a list of a wax, rubber, putty, silicone, plastic. The material may be made of one or a combination of materials which do not require mixing but have some or all of the necessary properties as aforementioned. The material may harden or set simply by being exposed to air and/or moisture. The material may not necessarily set but rather remain dense enough and resist deformation so as to maintain it's shape after the impression is withdrawn.

The present invention provides enhanced results with much greater ease, stability, and precision and accuracy, predictability and ease for the dentist. Additionally, the present invention provides much greater comfort for the patient. Accordingly the present invention greatly advances the art of dentistry.

While the present invention has been described with respect to various embodiments, various modifications may be made without departing from the spirit or scope of this invention.

Other objects and features will become apparent by reference to the following description and the drawings.

### BRIEF DESCRIPTION OF THE DRAWINGS

A detailed description of preferred embodiments of the claimed invention is provided herein below, with reference to the following drawings, in which:

FIG. 1 is a top view of a dental container and more specifically a maxillary impression tray.

FIG. 2 is a top view of a dental container and more specifically a mandibular impression tray.

FIG. 3 is a top view of a dental container and more specifically a maxillary impression tray, containing unset impression material, to which is attached a body which forms a boundary or border thereby confining impression material to the maxillary teeth and preventing spillage of said impression material towards the palate.

FIG. 4 is a top view similar to FIG. 3, additionally demonstrating a plurality of bodies comprising occlusal stops.

FIG. 5 is a top view of a dental container similar to FIG. 3 containing impression material which has hardened or set.

FIG. 6 is a top view similar to FIG. 4 containing impression material which has hardened or set.

FIG. 7 is a top view of a of a dental container similar to FIG. 2 demonstrating a plurality of bodies forming occlusal stops, which are embedded within impression material which has hardened or set.

FIG. 8 is a longitudinal cross sectional view of a of a dental tray or container filled with impression material demonstrating bodies comprising occlusal stops located in the anterior and posterior aspects of a container or tray.

FIG. 9 is a longitudinal cross sectional view of a dental container similar to FIG. 8 illustrating the placement of the dental container or tray over teeth until resistance is obtained by the engagement of the semi rigid compressive occlusal stops on the teeth.

FIG. 10 is a longitudinal cross sectional view of a of a dental container similar to FIG. 9 illustrating the complete seating of the dental tray or container over the teeth as the semi rigid compressive occlusal stops wrap around the distal and proximal teeth thereby rendering said tray more stable and secure as the soft impression material hardens or sets.

FIG. 11 represents a horizontal cross section of a dental container, or more specifically, a sectional impression tray, filled with unset impression material, and anterior and posterior bodies acting as occlusal stops.

FIG. 12 represents a horizontal cross section of a dental container, or more specifically, a sectional impression tray, as seen in FIG. 11 after it has been placed in the mouth and allowed to set and was subsequently removed from the mouth.

FIG. 13 is a horizontal cross section of a dental container, or more specifically, an impression tray, demonstrating a plurality of bodies comprising border/occlusal stops which are adjustable.

FIG. 14 is a horizontal cross section of a dental container, or more specifically, an impression tray as described in FIG. 13 that has been inserted over the teeth and further demonstrating how the proximal body comprising an occlusal stop has been adjusted on the tray to engage the proximal tooth and how the distal body comprising an occlusal stop has been adjusted to act as a boundary thereby directing the impression material towards the teeth and coincidentally limiting the expression of impression material out the open ended distal aspect of the tray.

FIG. 15 is a horizontal cross section of a dental container, or more specifically, an impression tray filled with unset impression material illustrating bodies comprising occlusal stops which have been adjusted in such a position as to engage teeth immediately adjacent to a single abutment tooth to be restored, further demonstrating how the bodies stabilize the tray during the setting time of the impression material as well as how they direct the impression material towards the abutment tooth and limit the expression of impression material out of the open end of the tray.

FIG. 16 is a horizontal cross section of a dental container, or more specifically, an impression tray filled with unset impression material illustrating bodies which have been adjusted in such a position as to engage teeth immediately adjacent to multiple abutment teeth to be restored.

FIG. 17 is a cross section of a maxillary dental container or tray illustrating an open end and a body acting as an occlusal stop as well as a boundary.

FIG. 18 is a cross section of a mandibular dental container or tray illustrating an open end and a body acting as an occlusal rest as well as a boundary.

### DETAILED DESCRIPTION OF PREFERRED EMBODIMENTS

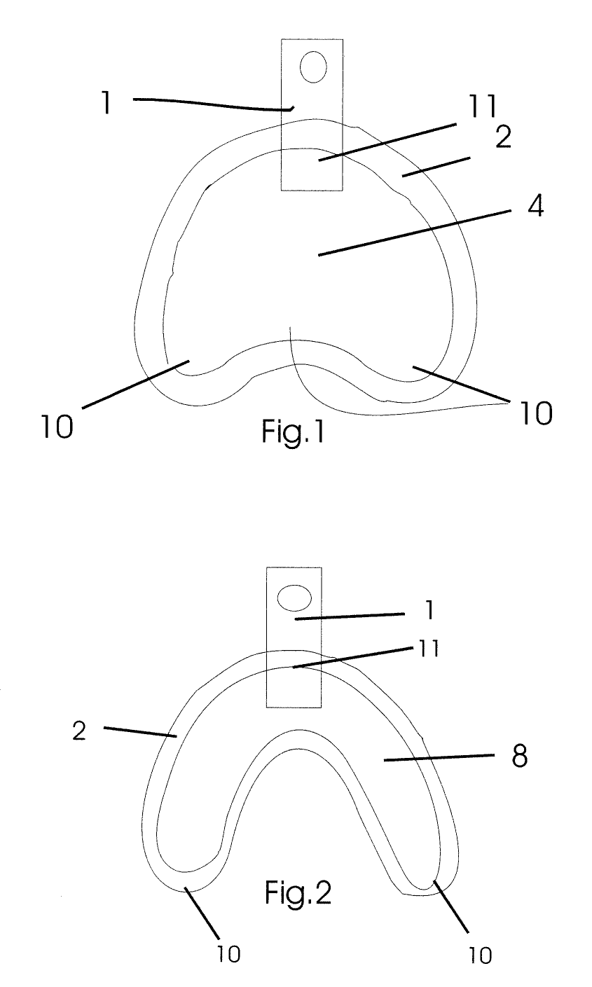

FIG. 1 Refers to a typical stock full arch maxillary impression tray with a handle 1 which attaches 11 to the impression tray and a palate 4. The impression tray has a rim or flange 2 which helps to retain the set impression material as the tray is withdrawn, and a distal end 10 which is open ended so as to be able to include teeth and oral structures of various shapes and sizes in the posterior aspects of the mouth. The open ended aspect 10 of dental impression trays contributes to spillage of impression material out of the tray towards the posterior aspects of the mouth contributing to patient discomfort and gagging. Similarly, the open aspect of the palate 4 causes spillage of impression material away from the teeth.

FIG. 2 illustrates a typical stock full arch mandibular impression tray with a handle 1 which is attached to the tray at 11. There is a rounded border 2 around the rim of the tray. A U-shaped channel 8 forms a receptacle that will contain the impression material. The posterior aspect 10 of the tray is flat and open ended so that various shapes and sizes of teeth and oral structures can be accommodated within the tray.

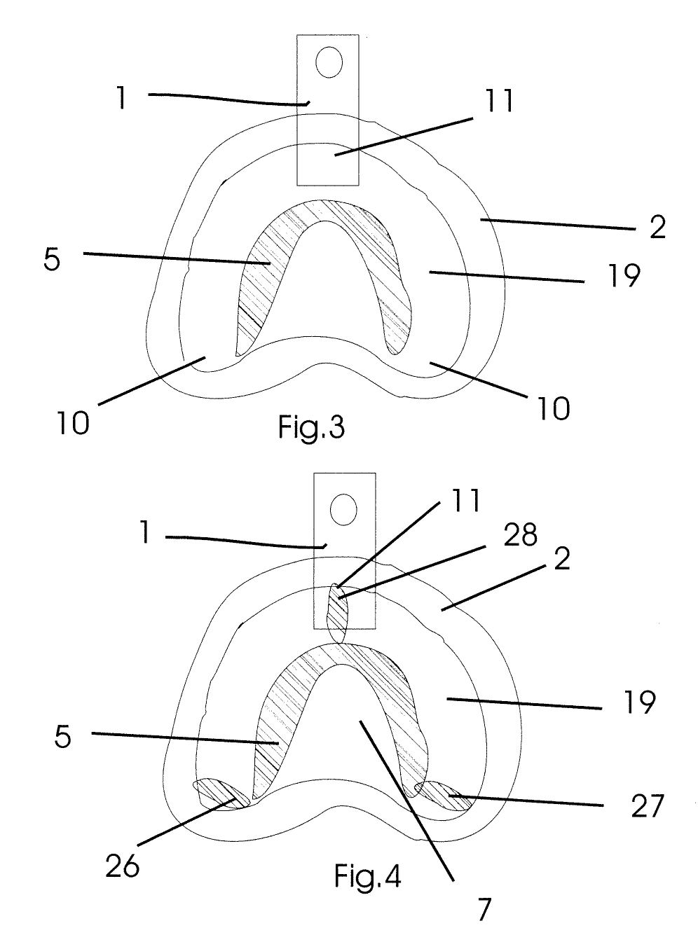

FIG. 3 is similar to FIG. 1 demonstrating a body acting as a border 5 which limits, confines and directs impression material 19, which has not yet hardened or set, away from the palate towards the area to be restored and which helps to stabilize the impression tray. The border 5 may be adjusted in position, length and height to accommodate a variety of teeth and configurations. This border 5 can be applied by the dentist or dental auxiliary to a stock or custom impression tray before the unset impression material 19 is inserted into said tray or can be applied during the manufacturing process of said tray.

FIG. 4 is similar to FIG. 3 additionally demonstrating bodies of material acting as occlusal rests 26, 27, 28, placed preferably in the proximal (closer to the handle1) and distal 10 areas. The occlusal stop 28 is situated in the anterior portion of the impression tray. The right 27 and left 26 posterior occlusal stops help to form a distal boundary which limits and confines the unset impression material 19 within the tray thereby preventing spillage into the posterior part of the mouth. It is preferable that the occlusal stops be positioned in the dental impression tray at the distal ends as well as the anterior area to form a tripod effect in order to offer a more stable result. The tripod effect of the occlusal rests is the most preferable configuration for a full arch impression producing stability and decreased movement while impression material is setting. The tripod effect of the occlusal rest 26, 27, 28, placement resists movement when pressure is exerted on the anterior 28 aspect, the right side 27 or the left side 26posterior aspects. It is preferable that impression trays which only partially cover an arch such as but not limited to sectional or quadrant, impression trays, contain only a posterior and anterior body, as the tripod effect is more important for full arch trays. The occlusal stop which is dense, (unlike the soft fluid impression material) offers resistance and also engages the corresponding teeth and/or oral structures increases stability of the tray as it grabs the corresponding teeth. and prevents the tray or container to be overly compressed minimizing deformation and inaccuracies.

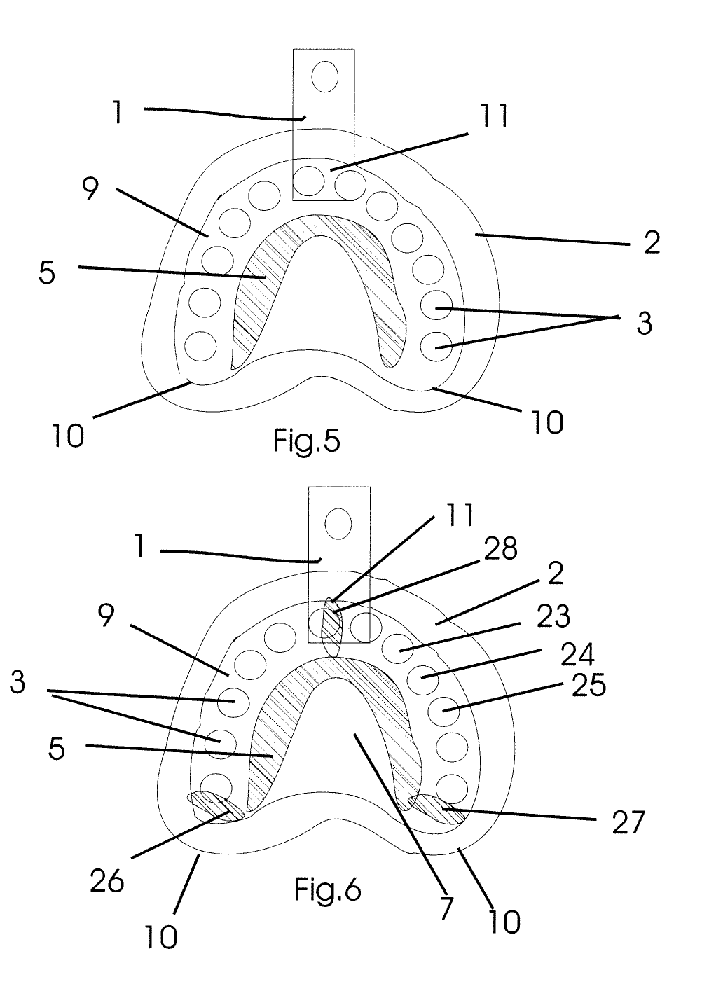

FIG. 5 is similar to FIG. 3 which is filled with impression material 9 which has set. The cavities 3 represent the impression of teeth in the set impression material 9. It should be noted that the border of material 5 acts to direct the impression material towards the teeth and away from the palate increasing precision, and patient comfort and reducing waste. A boundary or border can act like an occlusal stop engaging the palatal tissues, and increases tray stability.

FIG. 6 is similar to FIG. 5 additionally illustrating occlusal stop 6 located in proximal and distal ends of the tray. The distal 10 occlusal stop 6 serve to stabilize and direct impression material Impression as well as limit the spillage out the distal 10 open ends of the impression tray. An occlusal stop can therefore act as a stop as well as a boundary. Cavities 23, 24, 25, represent teeth #23, 24, 25. It is highly preferable that the occlusal stop be placed in areas of the tray which correspond to structures that will not be restored. For example if teeth #23, 24, 25, were to be restored, the occlusal stops would be preferably placed as indicated, and not in the area of 23, 24, or 25. A body acting as a border 5, can be composed of the same material as a body acting as an occlusal stop 26,27,28, and can function in the same manner. A border will serve to close or limit an open end of an impression tray (distal ends and facial aspect of the palate), and an occlusal stop, which is usually but not necessarily smaller, can be placed anywhere in the impression tray.

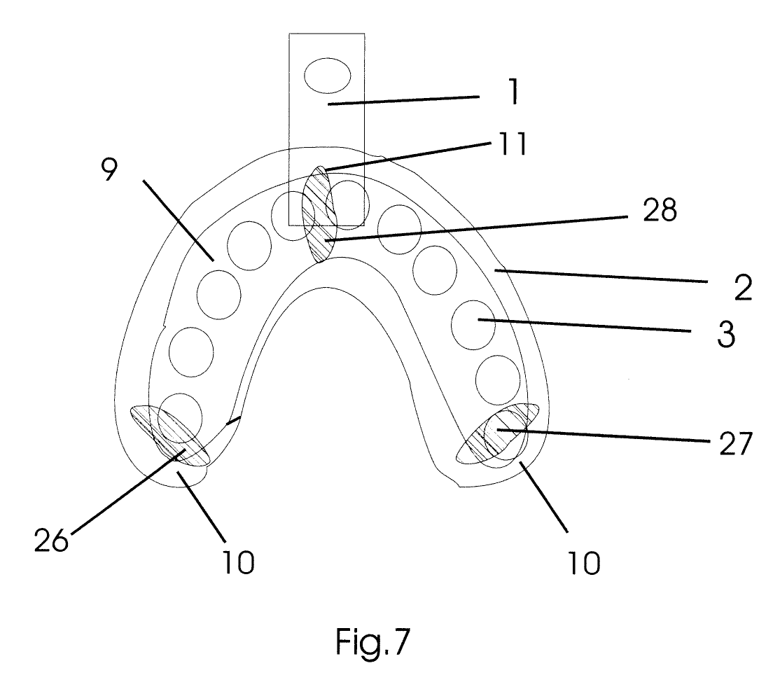

FIG. 7 illustrates a mandibular full arch impression tray similar to FIG. 2 indicating occlusal stops 26, 27, 28 and a set impression material 9 and cavities 3 within the set impression material representing a negative form of the mandibular teeth.The distal occlusal rests 26 and 27 serve to stabilize and direct impression material Impression as well as limit the spillage out the distal open ends 10 of the impression tray. The impression tray has a rim or flange 2 and a distal end 10 which is open ended so as to be able to include teeth and oral structures in the posterior aspects of the mouth. The open ended aspect 10 of dental impression trays contributes to spillage of impression material out of the tray towards the posterior aspects of the mouth contributing to patient discomfort and gagging. It is preferable that the occlusal stops be positioned in the dental impression tray at the distal ends as well as the anterior area to form a tripod effect in order to offer a more stable result. It is highly preferable that the occlusal stop be placed in areas of the tray which correspond to structures that will not be restored. An occlusal stop 26, 27, and can function in the same manner as a border and will serve to close or limit an open distal end of an impression tray. The tripod effect of the occlusal stop is the most preferable configuration for a full arch impression producing stability and decreased movement while impression material is setting. The tripod effect of the occlusal stop placement resists movement when pressure is exerted on the anterior 28 aspect, the posterior aspect, the right side 26, or the left side 27. There is no palate on a mandibular tray so there is no need for a palatal “border”. The occlusal stop which is dense, (unlike the soft fluid impression material) offers resistance and also engages the corresponding teeth and/or oral structures increases stability of the tray as it grabs the corresponding teeth and prevents the tray or container to be overly compressed minimizing deformation and inaccuracies. The occlusal stop 28 is situated in the anterior portion of the impression tray. The right 26 and left 27 posterior occlusal stops help to form a distal boundary which limits and confines the impression material within the tray thereby preventing spillage into the posterior part of the mouth.

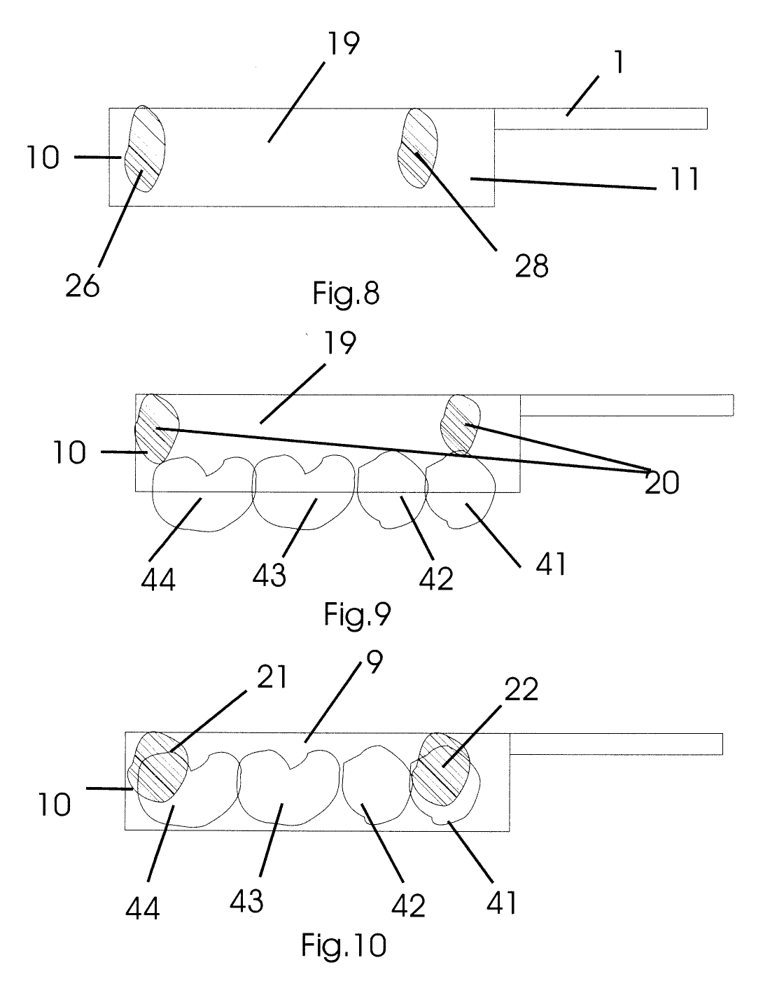

FIG. 8 Illustrates a longitudinal cross section of an impression tray indicating occlusal stops located on the distal 26 and proximal 28 aspects of said impression tray. The occlusal stops are placed within the tray in an anterior-posterior position to engage the distal and proximal teeth in the dental arch and are formed in an elongate manner extending just short of the rim 2 of the tray to more efficiently limit the spillage of the unset impression material out of the distal 10 open end of the impression tray and to engage the teeth in the distal and proximal aspects of the dental arch. It should be noted that the unset impression material 19 is preferably inserted into the impression tray completely covering the occlusal stops.

FIG. 9 illustrates the initial placement of the impression tray as in FIG. 8 over the teeth 41, 42, 43, 44, demonstrating the compression of the occlusal stops 20 as said rests engage the distal tooth 44 and the proximal tooth 41.

FIG. 10 illustrates the further and complete seating of an impression tray containing set impression material 9 over the teeth 41, 42, 43, 44. It should be noted that the occlusal stops 21 and 22 engage the distal 44 and proximal 41 teeth respectively and deform to engulf these teeth over the facial and inner and interproximal aspects thereby stabilizing the tray and limiting the movement of the tray as the impression material sets. The occlusal stops prevent the overseating of the impression tray so that the teeth do not touch the internal aspect of the tray, which would lead to distortion and inaccuracies. As impression material is inserted into the tray covering the occlusal stops which also act as a boundary, they are engulfed by and covered with impression material.

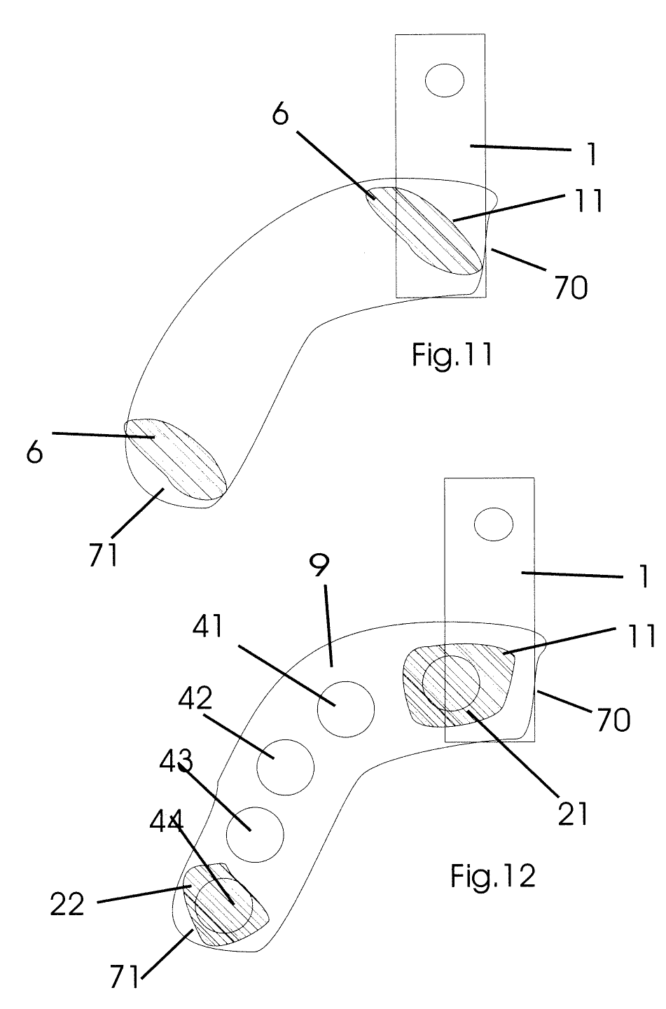

FIG. 11 refers to a quadrant or triple tray impression tray which is open ended in the proximal 70 and distal 71 ends and occlusal stops 6 which act as both an occlusal stop and a boundary. It is preferable that impression trays which only partially cover an arch such as but not limited to sectional or quadrant, impression trays, contain only a posterior and anterior body, as the tripod effect is more important for full arch trays.

FIG. 12 refers to the horizontal cross section of a quadrant or triple tray illustrating the further and complete compression of the set impression material 9 contained in the tray over the teeth 41, 42, 43, 44. It should be noted that the occlusal stops engage the distal 44 and proximal 41 teeth and deform to engulf these teeth thereby stabilizing the tray and limiting the movement of the tray as the impression material sets. In the case of a quadrant tray, the occlusal stops may prevent the overseating of the impression tray so that the teeth do not touch the internal aspect of the tray, which would lead to distortion and inaccuracies. As impression material is inserted into the tray covering the occlusal stops which also act as a boundary, they are engulfed by and covered with impression material.

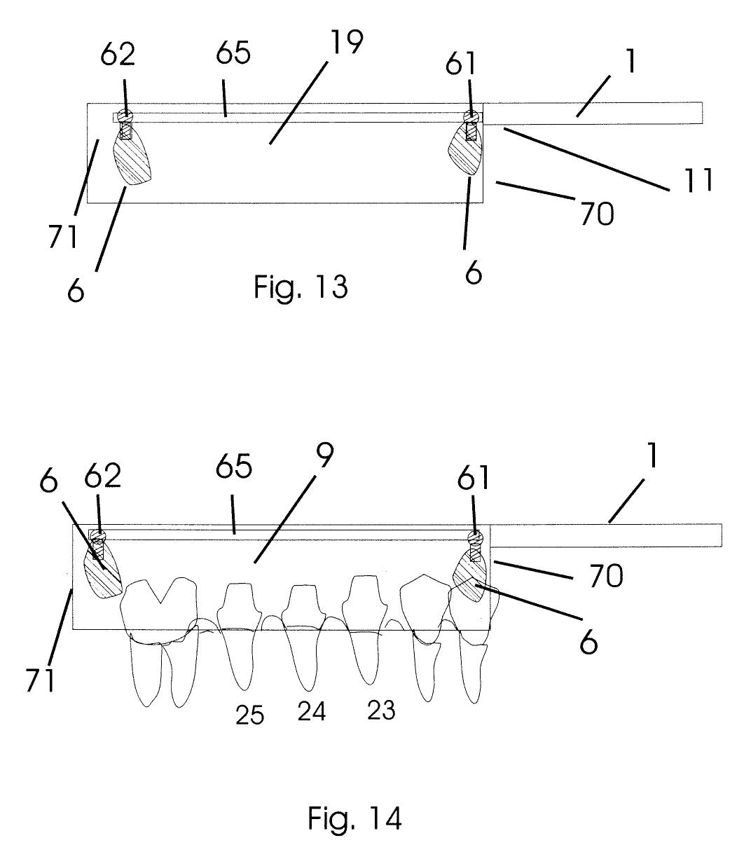

FIG. 13 illustrates a longitudinal cross section of an impression tray or container with a groove or slot 65 which allows for an operator to adjust the occlusal stops 6 in an anterior/posterior direction to accommodate various tooth forms and configurations. A body which acts like an occlusal stop is attached to a bracket 62 which is allowed to slide along a groove or slot 65. It is a preferred embodiment of the present invention for the bracket 62 to be locked in the desired position after being adjusted to engage the desired teeth, by way of example but not limited to a friction lock or a set screw or V-type locking device. In some cases it may be preferred to remove the bodies forming occlusal stops/boundaries after the impression material sets. In this case the bodies 6 are releasably adhered to the brackets 62 and 61, and impression material 19 is inserted between said occlusal stops and the impression material does not cover the bodies 6.

FIG. 14 illustrates the insertion of an impression tray as seen in FIG. 13 over a quadrant of teeth and more specifically tooth abutments 23, 24, 25 which have been prepared to receive a prosthetic. As can be evidenced, occlusal stops 6 have been adjusted by sliding a posterior bracket 62 to which has been attached a body serving as an occlusal rest 6, distally to engage the distal of the terminal tooth of the arch and sliding an anterior or proximal bracket 61 to engage the most anterior tooth in the arch. The impression material 9 is inserted over and covers the occlusal stops 6. It is preferable for the occlusal stops not to touch the abutment teeth to be restored as the loose lighter impression material may impinge on the more dense occlusal stops even very minimally.

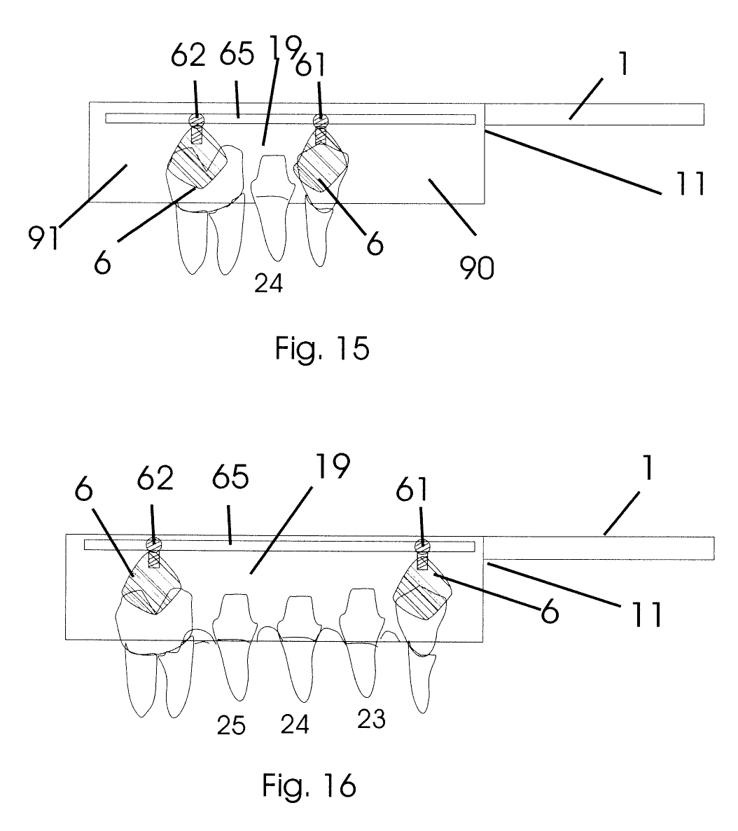

FIG. 15 illustrates the insertion of an impression tray filled with unset impression material 19 as seen in FIG. 13 over a quadrant of teeth and more specifically a single tooth abutment 24 which has been prepared to receive a prosthetic. As indicated in FIG. 14, the occlusal stops may be positioned to engage teeth adjacent to the abutment 24 by sliding the proximal 61 and distal 62 brackets to which have been attached bodies 6 acting as occlusal stops. The occlusal stops 6 act as a border or boundary as well, directing and limiting the impression material around the tooth abutment 24 and adjacent teeth so it is possible to save money and increase patient comfort by limiting impression material between the occlusal stops, leaving the anterior part 90 and the posterior 91 of the tray empty.

FIG. 16 illustrates the insertion of an impression tray, filled with unset impression material 19, as seen in FIG. 14 over a quadrant of teeth and more specifically tooth abutments 23, 24, 25 which have been prepared to receive a prosthetic in which both anterior (proximal) 61 and posterior (distal) occlusal rests 6 have been positioned to engage the occlusal surfaces of the anterior and posterior teeth.

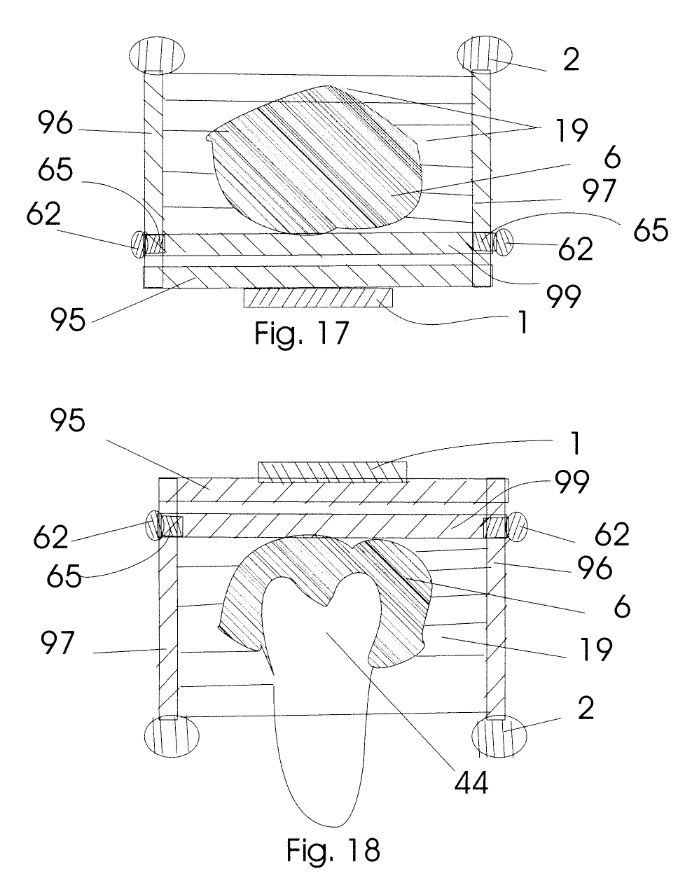

FIG. 17 illustrates a horizontal cross section of a container or impression tray, specifically a maxillary impression tray, a handle 1 affixed to the occlusal aspect 95 of the reservoir which is filled with unset impression material 19, a palatal wall 96, a rim 2, and a body 6 which is affixed to a plate 99 which is adjustably connected to the walls 96 and 97 of the impression tray by brackets 62 which are allowed to slide, in an anterior posterior direction, in a groove or channel 65.

FIG. 18 is similar to FIG. 17 for a mandibular container or impression tray that is filled with unset impression material 19 covering a body 6, that has been inserted over teeth and more specifically a tooth 44 demonstrating the body 6 engaging and partially engulfing said tooth thereby increasing stability and reducing movement. The semi rigid compressible body 6 offers resistance so that the tray does not fully compress against the occlusal portion of the tray, in this case being a plate 99. A body 6 may be affixed to the occlusal wall 95 of a tray, in which case no plate 99 nor bracket 62 need be present.

What is claimed is:

1. A tray or container which holds material to be used for the taking of a dental impression, which when placed in a mouth is stable, the device comprising:
a receptacle to hold said material; and
a body which has been affixed to a receptacle, said body which can be adjusted to engage teeth and oral structures.

2. A tray or container as in claim 1 in which said body engages teeth and oral structures and directs impression material to the areas to be restored and confines impression material within the tray or container.

3. A tray or container as in claim 1 which limits movement of said tray.

4. A tray or container as in claim 1 which has an occlusal stop.

5. A tray or container as in claim 1 which has a boundary.

6. A tray or container as in claim 1 which has an occlusal stop and a boundary.

7. A tray or container as in claim 1 in which the body is deformably rigid.

8. A tray or container as in claim 1 in which the body is flexible.

9. A tray or container as in claim 1 in which the body is adjustable in horizontal position in the tray or container.

10. A tray or container as in claim 1 in which the body is adjustable in vertical position in the tray or container.

11. A tray or container as in claim 1 in which the body is deformably rigid initially and then will set or harden.

12. A tray or container as in claim 11 in which the body will set or harden when exposed to air.

13. A tray or container as in claim 11 in which the body will set or harden when exposed to water.

14. A tray or container as in claim 11 in which the body will set or harden when exposed to saliva.

15. A tray or container as in claim 11 in which the body will set or harden when exposed to heat.

16. A tray or container as in claim 11 and in which the body will set or harden when exposed to light.

17. A tray or container as in claim 1 in which the body may be deformably rigid and not set.

18. A tray or container as in claim 1 in which said body is releasably adhered to the tray or container.

19. A tray or container as in claim 1 in which the body is incorporated into the tray or container during the manufacturing process.

20. A tray or container as in claim 1 in which the body may be adhered to the stock or custom tray or container before it is inserted into the mouth.

21. A tray or container as in claim 1 in which the body may comprise any or a plurality of, but not limited to a wax, putty, silicone, polyvinylsiloxane, polyether, rubber, or plastic.

22. A method of taking an impression for a dental procedure comprising:
(a) Placing or adjusting one or a plurality of bodies in a tray or container in a position so as to anchor onto teeth or oral tissues adjacent to the area to be restored;
(b) inserting impression material into the tray or container within the boundaries of the bodies or alternately;
(c) inserting impression material into the tray or container completely covering the body or plurality of bodies;
(d) inserting the tray or container filled with impression material into the mouth over the area to be restored;
(e) exerting pressure on the tray or container until slight resistance of the body is felt;
(f) allowing the tray or container to remain over the site to be restored until the impression material sets;
(g) withdrawing the tray or container from the mouth.

23. A method of taking an impression for dental procedure comprising:
(a) releasably affixing one or a plurality of bodies in a tray or container in a position so as to anchor onto teeth or oral tissues adjacent to the area to be restored;
(b) inserting impression material into the tray or container within the boundaries of the bodies;
(c) inserting the tray or container filled with impression material into the mouth over the area to be restored;
(d) exerting pressure on the tray or container until slight resistance of the body or plurality of bodies is felt;
(e) allowing the tray or container to remain over the site to be restored until the impression material sets;
(f) withdrawing the tray or container from the mouth;
(g) removing the body or plurality of bodies from the impression before pouring the impression.
